(19) United States
(12) Patent Application Publication
(10) Pub. No.: US 2013/0131220 A1
(43) Pub. Date: May 23, 2013

(54) EMULSION OR REDISPERSIBLE POLYMER POWDER OF A POLYMER COMPRISING A BIOMONOMER, A PROCESS TO PREPARE THEM, AND THE USE THEREOF IN BUILDING MATERIAL COMPOSITIONS

(71) Applicants: Alexander Zapf, Obfelden (CH); Thomas Scherer, Sempach (CH)

(72) Inventors: Alexander Zapf, Obfelden (CH); Thomas Scherer, Sempach (CH)

(73) Assignee: AKZO NOBEL CHEMICALS INTERNATIONAL B.V., Amersfoort (NL)

(21) Appl. No.: 13/697,080

(22) PCT Filed: May 9, 2011
(86) PCT No.: PCT/EP2011/057374

§ 371 Date: Dec. 11, 2012

Related U.S. Application Data
(60) Provisional application No. 61/345,376, filed on May 17, 2010.

(30) Foreign Application Priority Data
May 12, 2010 (EP) 10 162 720.6

(51) Int. Cl. C08L 35/02; C04B 26/06

(52) U.S. Cl. CPC C08L 35/02; C04B 26/06
USPC 524/5; 524/533

(57) ABSTRACT

The present invention relates to process to prepare a polymer by an aqueous emulsion or suspension polymerisation process wherein a monomer mixture is polymerised in the presence of a free radical initiator and a stabiliser, to the emulsion and redispersible polymer powder obtainable therewith, and to the use of this emulsion and powder in a building material composition, in particular to hydrophobise the building material composition, wherein the monomer mixture comprises (i) 0.5-80 wt. % of biomonomers containing an ester of a polyol and at least one fatty acid, the polyol having 2 to 10 hydroxy groups, and at least one vinyl group; (ii) 20-99.5 wt. % of vinyl monomers chosen from the group of vinyl esters, (meth)acrylic esters, vinyl aromatic compounds, vinyl halides, and olefins; and (iii) 0 to 20 wt % of vinyl monomers that are different from monomer (ii) and contain at least one functional group chosen from the group of alkoxysilane, glycidyl, epoxy, epihalohydrin, nitrile, carboxyl, amine, ammonium, amide, imide, N-methylol, isocyanate, hydroxyl, thiol, keto, carbonyl, acid anhydride, aceto acetonate, sulfonic acid groups, and salts thereof, and the stabiliser comprises (a) 50 to 100 wt. % of a protective colloid; and (b) 0 to 50 wt. % of an emulsifier.

The present invention relates to an emulsion or redispersible polymer powder of a polymer that comprises a biomonomer, to a process to prepare this emulsion or powder, and to the use thereof in building material compositions.

In the building industry often use is made of additives in the form of either aqueous emulsions or redispersible polymer powders, which additives contain a polymer of ethylenically unsaturated monomers like (meth)acrylates, styrenes or vinyl esters.

Such additives are added to building material compositions to improve the properties of the building material composition.

For example, WO 2009/156163 discloses the preparation of a water-redispersible polymer powder composition containing at least one water-insoluble synthetic polymer, at least one natural latex, at least one protective colloid, at least one filler and/or anti-caking agent, and, optionally, further additives; and the use thereof as an additive in building material compositions. It is indicated that the synthetic polymer can be based on monomers such as vinyl acetate, ethylene, vinyl versatate, vinyl laurate, vinyl chloride, (meth)acrylate, styrene, and butadiene.

The monomers used for preparing (synthetic) polymers, such as the above (meth)acrylates, styrenes or vinyl esters, are normally derived from petrochemical resources. As petrochemical resources will become increasingly exhausted in the coming decades, however, there is a need in the industry to switch to monomers that can be derived from renewable sources.

GB 1152 859 discloses a vinyl acetate polymer dispersion in which one monomer is the vinyl ester of a fatty acid, and more explicitly vinyl laurate. The dispersion is stabilised by the addition of a surfactant and can be used in coatings.

U.S. Pat. No. 6,235,916 discloses an aqueous dispersion of a polymer comprising as a monomer a compound derived from a semi- or non-drying oil that is polymerised with ethylenically unsaturated monomers. The dispersion is stabilised by a surface-active agent. In addition, it is disclosed that a protective colloid may also be added to the dispersion. In the Examples mixtures of surfactants and protective colloids are disclosed, but always the surfactant is present in a significantly higher amount in weight than the protective colloid. The dispersion is useful in coatings, adhesives, and inks.

US 2009/0312494 discloses a process for preparing a grafted copolymer with a polyunsaturated fatty acid using a mini-emulsion polymerisation process in the presence of a surfactant. The surfactant can be combined with a water-soluble polymer, but no disclosure is made as to amounts. The grafted copolymer can be dried to give a redispersible polymer powder. The copolymer can be used as a binder in coating compositions, adhesives or mineral binder compositions, such as a mortar.

It is noted that mini-emulsion polymerisation is a complex process requiring a multi-step procedure with special, high shear equipment for making a mini-emulsion. Such mini-emulsions have a small droplet size with a mean diameter of e.g. 100 nm or lower. Upon polymerisation, the droplet size remains about unchanged, since the monomers remain inside the droplets. Thus, this is kind of polymerisation is used to polymerize monomers with no or only a very low water solubility. However, such droplets have a distinct larger surface, which requires significantly more water-soluble polymeric stabiliser to make e.g. redispersible polymer powders. However, an increased amount of water-soluble polymeric stabiliser often has an adverse effect on the properties of a cured building material composition, e.g. on its water resistance.

Furthermore, in the building industry surfactants (also called emulsifiers or surface-active agents) are less desired and instead more use is made of protective colloids when preparing polymers for use in building material compositions. This is, for example, because surfactant-stabilised emulsions most often cause problems when they are spray dried.

It has now been found that it is possible to make polymers containing (macro)monomers that are based on a fatty acid or derivative thereof using a (classic) emulsion or suspension polymerisation process using a protective colloid. In addition, it has proved possible to dry these aqueous dispersions of polymer to give redispersible polymer powders that can be used in the building industry, as well as the aqueous emulsions.

Accordingly the present invention provides a process to prepare a polymer by an aqueous emulsion or suspension polymerisation process wherein a monomer mixture is polymerised in the presence of a free radical initiator and a stabiliser, wherein the monomer mixture comprises
(i) 0.5-80 wt. % of biomonomers containing an ester of a polyol and at least one fatty acid, the polyol having 2 to 10 hydroxy groups, and at least one vinyl group;
(ii) 20-99.5 wt. % of vinyl monomers chosen from the group of vinyl esters, (meth)acrylic esters, vinyl aromatic compounds, vinyl halides, and olefins; and
(iii) 0 to 20 wt. % of vinyl monomers that are different from monomers (ii) and contain at least one functional group chosen from the group of alkoxysilane, silanol, glycidyl, epoxy, epihalohydrin, nitrile, carboxyl, amine, ammonium, amide, imide, N-methylol, isocyanate, hydroxyl, thiol, keto, carbonyl, acid anhydride, aceto acetonate, sulfonic acid groups, and salts thereof,
and the stabiliser comprises
(a) 50 to 100 wt. % of a protective colloid; and
(b) 0 to 50 wt. % of an emulsifier

The indication of quantity of the used components relates to the sum of the respective amounts and adds up to 100 wt. %.

The process according to the invention leads to emulsions and dispersions. These terms are interchangeable and include also the products obtained from suspension polymerisation.

Especially in cases where monomers become larger and therefore bulkier, a skilled person would be much more tempted to make use of mini-emulsion technology or—alternatively—to use surfactants instead of protective colloids in emulsion or suspension polymerisation. This is because surfactants, when part of a micelle or stabilizing a growing emulsion polymer particle, are mobile and not chemically bound to the polymer chains. The stabilizing layer containing primarily surfactants and no, or to a lesser extent, protective colloid also enables macromonomers to diffuse into the micelle. By contrast, protective colloids such as polyvinyl alcohol are not only less mobile due to a much higher molecular weight, but they also become grafted—and thus chemically linked—to the polymer being formed by emulsion polymerisation. Therefore, it was surprising to find that macromonomers with relatively high molecular weights can easily be copolymerised in protective colloid-stabilised systems even in high amounts.

Accordingly, using the process of the invention it is possible to use protective colloids instead of surfactants as a major part of the stabiliser and it is even possible to use the protective colloid as sole or main stabiliser.

The present invention also provides a process to prepare a (redispersible) powder or granulate wherein the above emulsion is dried in a subsequent step to give a powder, a redispersible polymer powder, in particular a water-redispersible polymer powder, or granulate.

In addition, the present invention provides the emulsion and the redispersible polymer powder obtainable by the above processes. The emulsion and the redispersible polymer powder of the invention contain a polymer comprising
(i) 0.5-80 wt. % of biomonomers containing an ester of a polyol and at least one fatty acid, the polyol having 2 to 10 hydroxy groups, and at least one vinyl group;
(ii) 20-99.5 wt. % of vinyl monomers chosen from the group of vinyl esters, (meth)acrylic esters, vinyl aromatic compounds, vinyl halides, and olefins; and
(iii) 0 to 20 wt. % of vinyl monomers that are different from monomers (ii) and contain at least one functional group chosen from the group of alkoxysilane, silanol, glycidyl, epoxy, epihalohydrin, nitrile, carboxyl, amine, ammonium, amide, imide, N-methylol, isocyanate, hydroxyl, thiol, keto, carbonyl, acid anhydride, aceto acetonate, sulfonic acid groups, and salts thereof,
and the stabiliser comprises
(a) 50 to 100 wt. % of a protective colloid; and
(b) 0 to 50 wt. % of an emulsifier.

Moreover, the present invention provides the use thereof in building material compositions and covers building material compositions containing the emulsion or redispersible polymer powder and at least one mineral binder or filler material.

The redispersible polymer powder, also called polymer powder, according to the invention was found to be free-flowing and to have good anti-caking properties. Thus it can be stored even for a prolonged time at e.g. 40° C. without caking. When in contact with water, it shows very good wettability and redispersibility, so that already on contact with water within a few seconds, often after light stirring, the mixture can be fully redispersed. This means that the polymer powder disintegrates finally to particles having the size of the emulsion particles before drying.

When a film is cast from the emulsion or redispersed powder at ambient conditions, it shows a high flexibility and elasticity. In addition, the polymer powder can be used in many different ways and is very readily miscible with all sorts of dry mortar mixtures. When the dry mortar containing the redispersible polymer powder is mixed with water, applied, and cured, it imparts excellent adhesion and cohesion properties. Furthermore, the cured mortar shows an improved flexibility as compared with mortars which are not polymer modified.

As an additional advantage the polymer of the present invention was found to be very suitable to provide hydrophobic, thus water-repellent, properties to building material compositions. And it is of particular advantage that the bulk of the cured building material composition is hydrophobised, and thus mass-hydrophobised, since this effect remains in force also after the surface of the building material composition is damaged. Accordingly, the present invention provides a process to hydrophobise a building material composition by adding the emulsion or redispersible polymer powder of the invention to the uncured building material composition before and/or during mixing it with water. Such process comprises the steps of mixing the uncured building material composition, the emulsion or redispersible polymer powder, and water, applying it onto a substrate, and allowing it to cure.

As a further additional advantage the polymer of the present invention was found to be very suitable to provide freeze-thaw stability to cured building material compositions. Accordingly, the present invention provides a process to improve the freeze-thaw stability of a cured building material composition by adding the emulsion or redispersible polymer powder of the invention to the uncured building material composition. Such process comprises the steps of mixing the uncured building material composition, the emulsion or redispersible polymer powder, and water, applying it onto a substrate, and allowing it to cure.

Also, it was found that polymers/dispersions having a minimum film formation temperature (MFFT) of 5° C. or lower and an improved saponification resistance can be obtained. In state of the art polymers often VeoVa® monomers are used to provide hydrophobicity, low Tg, and saponification resistance to polymers. Consequently, the present invention provides a suitable alternative to the use of VeoVa based materials, whereby a disadvantage of VeoVa® caused by its limited commercial availability is overcome. However, it was a big surprise to find that when VeoVa is only partly replaced by the biomonomer (i), a distinctly enhanced hydrophobicity is observed which is obtained neither by VeoVa nor by the biomonomer alone. It is thus believed that this is due to a synergistic effect between the two monomer types.

In this specification emulsifier (which is used as a synonym for surfactant or surface-active agent) stands for any material that contains both hydrophobic groups (tails) and hydrophilic groups (heads). Emulsifiers thus reduce the interfacial tension between non aqueous and aqueous materials by absorbing at the liquid-liquid interface. Emulsifiers usually function by the formation of aggregates, also called micelles. When micelles form in water, their tails form a core that can encapsulate an oil droplet, and their (ionic/polar) heads form an outer shell that maintains favourable contact with water. When surfactants assemble in oil, the aggregate is referred to as a reverse micelle. In a reverse micelle, the heads are in the core and the tails maintain favourable contact with oil. Surfactants can be chosen from four groups; anionic, cationic, non-ionic, and zwitterionic (dual charge) compounds. They are well known to the skilled person, who can easily make the best selection.

The terms dispersion and emulsion according to the invention are used as synonyms and refer to polymer particles obtained by emulsion polymerisation which are dispersed in a continuous medium with a stabiliser system. The continuous medium is for aqueous emulsions.

The Stabiliser

In a preferred embodiment, the stabiliser comprises 75 to 100 wt. % of protective colloid and 0 to 25 wt. % of emulsifier, even more preferably 90 to 100 wt. % of protective colloid and 0 to 10 wt. % of emulsifier, most preferably 95 to 100 wt. % of protective colloid and 0 to 5 wt. % of emulsifier.

The stabiliser used during emulsion polymerisation in one embodiment is used in an amount of about 3 to 15 wt. % based on the dry weight of the monomer mixture, preferably about 4 to 12 wt. %.

Protective colloids for use in emulsion polymerisation are well known to the person skilled in the art and non-limiting examples are given below.

The stabiliser can in addition contain one partially water-soluble or water-insoluble ionic colloid prepared according to for instance EP 1 098 916, EP 1 109 838, EP 1 102 793, and EP 1 923 405. In addition, it is also possible to use additionally or as protective colloid one or several natural or synthetic polymers which are only soluble in the alkaline pH-range, which means that at least about 50 wt. %, preferably at least about 70 wt. %, in particular about 90 wt. %, will dissolve in water with a pH-value of 10 as a 10 wt. % solution at 23° C. Non-limiting examples of these are poly(meth)acrylic acids and the copolymers thereof.

Representative synthetic protective colloids which can be used according to the invention are for example one or several polyvinyl pyrrolidones and/or polyvinyl acetals with a molecular weight of 2,000 to 400,000, fully or partially saponified polyvinyl alcohols and the derivatives thereof, which can be modified for instance with amino groups, carboxylic acid groups and/or alkyl groups, with a degree of hydrolysis of preferably about 70 to 100 mol. %, in particular of about 80 to 98 mol. %, and a Floppier viscosity in 4% aqueous solution of preferably 1 to 100 mPas, in particular of about 3 to 50 mPas (measured at 20° C. in accordance with DIN 53015), as well as melamine formaldehyde sulfonates, naphthaline formaldehyde sulfonates, polymerizates of propylene oxide and/or ethylene oxide, including also the copolymerizates and block copolymerizates thereof, styrene-maleic acid and/or vinyl ether-maleic acid copolymerizates.

Preferred synthetic protective colloids are partially saponified, optionally modified, polyvinyl alcohols with a degree of hydrolysis of 80 to 98 mol. % and a Floppier viscosity as 4% aqueous solution of 1 to 50 mPas and/or polyvinyl pyrrolidone.

In a further embodiment, natural and/or synthetically prepared protective colloids can be chosen from the group of biopolymers such as polysaccharides and polysaccharide ethers, for instance cellulose ethers such as hydroxyalkyl-cellulose and/or alkyl-hydroxyalkyl-cellulose, in which case the alkyl group may be the same or different and preferably is a C₁-to C₆-group, in particular a methyl, ethyl, n-propyl and/or i-propyl group, carboxymethyl cellulose, starch and starch ethers (amylose and/or amylopectin and/or the derivatives thereof), guar ethers, dextrins, agar-agar, gum arabic, carob seed grain, pectin, gum tragacanth and/or alginates. Often it is advantageous when these are soluble in cold and/or alkaline water. The polysaccharides can, but do not need to be, chemically modified, for instance with carboxymethyl, carboxyethyl, hydroxyethyl, hydroxypropyl, methyl, ethyl, propyl, sulfate, phosphate, and/or long-chain alkyl groups. As synthetic polysaccharides can be used for instance anionic, non-ionic or cationic heteropolysaccharides, in particular xanthan gum, welan gum and/or diutan gum. Preferred peptides and/or proteins to be used are for instance gelatin, casein and/or soy protein.

Preferred biopolymers are dextrins, cellulose ethers, carboxymethyl cellulose, starch, starch ethers, casein, soy-protein, gelatin, as well as hydroxyalkyl-cellulose and/or alkyl-hydroxyalkyl-cellulose, in which case the alkyl group may be the same or different and preferably is a C₁- to C₆-group, in particular a methyl, ethyl, n-propyl and/or i-propyl group.

During the emulsion polymerisation process, the protective colloid fraction can either be included completely in the initial charge or, alternatively, be included partly in the initial charge and partly metered in. In yet another embodiment, the protective colloid, or a portion of it, can be mixed first with the monomer to form a pre-emulsion, which then can be metered in as such.

Preferably, at least 5 wt. % of the protective colloid is included in the initial charge; most preferably, all of the protective colloid fraction is included in the initial charge.

Biomonomer (i)

Biomonomer (i) is a macromonomer with an entity which is preferably derived from a natural and renewable feedstock, in particular from one or more natural plant oils. This entity comprises an ester of a polyol that has 2 to 10 hydroxy groups and at least one fatty acid. It represents preferably at least 50%, expressed in molar weight, of biomonomer (i). The remainder represents one or more chemical groups which are reacted onto said entity, wherein at least one chemical group contains a vinyl group which is capable of reacting in radical polymerisations with other vinyl groups. While it is preferred that the entity is indeed derived from a natural and renewable feedstock, it is also possible that this entity is obtained through chemical synthesis.

The biomonomers (i) containing an ester of a polyol that has 2 to 10 hydroxy groups and at least one fatty acid and a vinyl group will also simply be referred to in this application as biomonomer or macromonomer (i).

The vinyl group is defined as an ethylenically unsaturated end group, i.e. a group of the formula —CH═CH₂ or —C(CH₃)═CH₂.

In a preferred embodiment, the vinyl group of biomonomer (i) is part of a styrenyl, acrylate, methacrylate and/or vinyl ether group, which can be illustrated by the formulae below

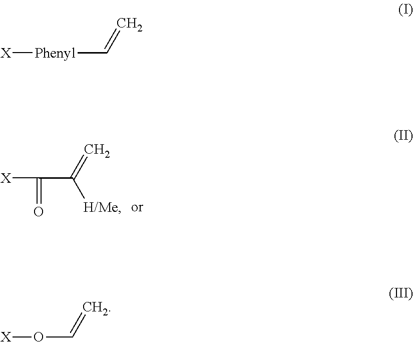

The vinyl group in one embodiment is incorporated into biomonomer (i) by a reaction of at least one molecule that introduces the vinyl group with the ester of the polyol and the at least one fatty acid.

The polyol in one embodiment is selected from the group of glycol, glycerol, hydroxypropanol, pentaerythritol, 1,1,1-trimethylol propane, 1,1,1-trimethylol ethane, 1,2,3-trimethylol propane, di-trimethylolpropane, di-pentaerythritol, ethylene glycol, propylene glycol, neopentyl glycol, 2-butyl-2-ethyl-1,3-propane diol, 1,6-hexane diol, cyclohexane dimethanol. The polyol can also be a compound in addition containing a group that is easily converted to a hydroxyl group, such as an epoxy group or an easily hydrolyzable ester group.

The fatty acid in one embodiment is selected from oleic acid, linoleic acid, α-linoleic acid, γ-linoleic acid, myristoleic acid, arachidonic acid, sapienic acid, erucic acid, palmitoleic acid, gadoleic acid, cetoleic acid, undecylenic acid, punicic acid, or a fatty acid derived from rapeseed oil, castor oil, safflower oil, linseed oil, soybean oil, sesame oil, poppyseed oil, perilla oil, hempseed oil, grapeseed oil, sunflower oil, maize oil, tall oil, whale oil, hevea oil, tung oil, walnut oil, peanut oil, canola oil, cottonseed oil, sugarcane fatty acid.

In the embodiments wherein the polyol is glycerol, the ester of the polyol and the fatty acid preferably is a natural oil that may be partly saponified, which is modified to contain a vinyl group. If the natural oil is partly saponified, it is preferably saponified to the extent that on average more than one fatty acid ester bond remains intact.

In embodiments wherein the polyol is a compound other than glycerol, the biomonomer, i.e. macromonomer (i), is often based on a synthetic ester, i.e. the reaction product of an esterification of the polyol and the at least one fatty acid, and if needed, modified to contain a vinyl group.

In yet another preferred embodiment, 30 to 100% of the hydroxyl groups of the polyol are esterified with a fatty acid group, even more preferably 60 to 100%, most preferably 95 to 100%.

In other preferred embodiments the ester reaction product of the polyol and the at least one fatty acid first reacts with at least one bridging molecule and subsequently with a molecule that introduces the vinyl group by reaction with the at least one bridging molecule, wherein the bridging molecule is a molecule that is capable of reacting with a hydroxyl group or an unsaturated bond of the ester of the polyol that has 2 to 10 hydroxy groups and at least one fatty acid, and thus the entity, and subsequently with a molecule that introduces the vinyl group.

Thus, the bridging molecule has at least two different functional groups. If the bridging molecule reacts with conjugated unsaturated bonds of the entity, one functional group of the bridging molecule may itself have an olefinically unsaturated bond which is capable of undergoing a Diels Alder reaction with the entity. In another embodiment, an olefinically unsaturated bond of the entity may react with a functional group of the bridging molecule which forms a radical. If the bridging molecule reacts with a hydroxyl group of the entity, the functional group of the bridging molecule may be an epoxy, anhydride, epichlorohydrine, carbonyl, aldehyde, ester, carbonic acid or carbonic acid chloride group.

The other functional group of the bridging molecule is preferably different from the first functional group or at least imparts a distinct different reactivity in order to enable the targeted reactions and thus reduce the number of side reactions. This functional group is preferably chosen to react easily with the functional group of the molecule that introduces the vinyl group. Thus, the other functional group of the bridging molecule preferably selected from the group of amine, hydroxyl, thiol, epoxy, anhydride, epichlorohydrine, carbonyl, aldehyde, ester, carbonic acid or carbonic acid chloride group.

Non-limiting examples of bridging molecules are anhydrides such as maleic anhydride, itaconic anhydride, fumaric anhydride, N-[3-(dimethylamino)-propyl]-acrylamide, N,N-[3-(chloro-2-hydroxypropyl)-3-dimethyl ammonium propyl]-acryl-amide chloride, N-[3-(dimethylamino)-propyl]-methacrylamide, N,N-[3-(chloro-2-hydroxypropyl)-3-dimethyl ammonium propyl]-methacrylamide chloride, N-[3-(dimethylamino)-propyl]-acrylate, N,N-[3-(chloro-2-hydroxypropyl)-3-dimethyl ammonium propyl]-acrylate chloride, N-[3-(dimethylamino)-propyl]-methacrylate, N,N-[3-(chloro-2-hydroxypropyl)-3-dimethyl ammonium propyl]-methacrylate chloride, glycidyl acrylate, glycidyl methacrylate, and the like. The skilled person is well aware of bridging molecules with suitable functional groups.

In a preferred embodiment, one or more olefinically unsaturated bonds of the ester are epoxidised and the epoxy group is reacted with a functional group of a molecule that introduces the vinyl group, for instance an amine or hydroxyl group. In this embodiment, no bridging molecule is required.

The molecule that introduces the vinyl group in one embodiment has a functional group that is capable of reacting with the polyol, the at least one fatty acid chain of the fatty acid ester, or with the bridging molecule.

This molecule introducing the vinyl group in a preferred embodiment can be selected from the group of (meth)acrylates, styrenes, vinyl estershaving a functional group that is capable of reacting with a hydroxyl group, an unsaturated bond, an anhydride, an epoxide or a carboxyl group in the reaction product of the polyol, and the at least one fatty acid, and, optionally, the bridging molecule.

The functional group can suitably be an epoxy, anhydride, epihalohydrin, ester, ketone, acid, amine, thiol or hydroxyl group if it binds to the hydroxyl group.

The molecule when it binds to the unsaturated bond of the ester can suitably be bonded thereto through a Diels Alder reaction, or a free radical reaction, with free radical initiators such as thermal or redox initiators being used. Such initiators are well known to the skilled person and include peroxide, persulfate, and azo compounds.

Preferably, biomonomer (i) has a molecular weight of at least 250 g/mole, more preferably at least 500 g/mole, most preferably at least 700 g/mole. Preferably, biomonomer (i) has a molecular weight of less than 10,000 g/mole, more preferably less than 5,000 g/mole, most preferably less than 2,500 g/mole.

Suitable biomonomers are disclosed in EP-A-2 702 544, EP-A-2 075 322, and EP-A-2 075 322, the contents of which are incorporated herein by reference. It should be noted that although these documents disclose biomonomers that are of use in the present invention, they neither disclose nor suggest emulsions or powders that are prepared or stabilised as in the present invention.

Vinyl Monomer (ii)

Vinyl monomer (ii) is preferably selected from vinyl esters, (meth)acrylic esters, vinyl halides, vinyl aromatic compounds, and olefins.

Vinyl monomer (ii) is different from biomonomer (i) and the vinyl monomer with functional group (iii).

Suitable vinyl esters are one or more monomers from the group of vinyl esters of branched or unbranched carboxylic acids having 1 to 20 carbon atoms. Preferred vinyl esters are vinyl acetate, vinyl propionate, vinyl butyrate, vinyl 2-ethylhexanoate, vinyl laurate, 1-methylvinyl acetate, vinyl pivalate, vinyl versatate being the vinyl ester of versatic acid, which is the vinyl ester of a highly branched carboxylic acid with 9, 10 or 11 carbons (VeoVa 9/10/11), vinyl decanoate, vinyl stearate, vinyl pyrrolidone. Vinyl acetate, vinyl laurate, and VeoVa 9/10/11 are particularly preferred.

Suitable (meth)acrylic esters and (meth)acrylamide monomers are the linear, cyclic or branched C₁- to C₂₀-alkyl esters and amides. Preferred C₁- to C₁₂-alkyl groups of (meth-)acrylic acid esters and (meth-)acrylamides are methyl, ethyl, propyl, n-butyl, i-butyl, t-butyl, hexyl, cyclohexyl, 2-ethylhexyl, lauryl, stearyl, norbornyl, polyalkylene oxide and/or polyalkylene glycol groups, in particular methyl, butyl, 2-ethylhexyl groups. Preferred methacrylic esters or acrylic esters are methyl acrylate, methyl methacrylate, ethyl acrylate, ethyl methacrylate, propyl acrylate, propyl methacrylate, n-butyl acrylate, i-butyl acrylate, n-butyl methacrylate, i-butyl methacrylate, 2-ethylhexyl acrylate, stearyl acrylate, stearyl methacrylate, and norbornyl acrylate. Preferred methacrylamides or acrylamides are N-alkyl acrylamides with C₁- to C₁₂-alkyl groups

Methyl methacrylate, n-butyl acrylate, 2-ethylhexyl acrylate, stearyl (meth)acrylate, and norbornyl acrylate are particularly preferred.

From the group of vinyl halides it is common to use vinyl chloride, though vinylidene chloride is also an option.

From the group of olefins ethylene, propylene, isoprene, and butadiene are typically used.

From the group of vinyl aromatic compounds styrene, styrene derivatives, such as alpha-methylstyrene, ortho-chlorostyrene or vinyl toluene, vinyl esters of benzoic acid, and p-tert-butylbenzoic acid are preferred.

In one embodiment, vinyl monomer (ii), which is a vinyl ester, (meth)acrylate or (meth)acrylamide having a C₈-C₃₀ alkyl or alkenyl group, preferably a C₈-C₂₀ alkyl or alkenyl group, in particular a C₁₀-C₂₀ alkyl or alkenyl group, comprises one or more hydrophobic monomers. It was found that the combination of such hydrophobic monomers with biomonomer (i) give a synergistic effect, in particular leading to increased hydrophobicity of the cured building material composition. The amount of hydrophobic monomers may be between 0.1 wt. % to 80 wt. %, preferably between 1 and 60 wt. %, of the total amount of vinyl monomer (ii).

Non-limiting examples of such hydrophobic monomers are vinyl 2-ethyl hexanoate, vinyl laurate, VeoVa 9/10/11, vinyl decanoate, vinyl stearate, 2-ethylhexyl acrylate, stearyl acrylate, stearyl methacrylate.

Comonomer (iii)

The vinyl monomer with at least one functional group (iii) and containing at least one functional group chosen from the group of alkoxysilane, glycidyl, epoxy, epihalohydrin, nitrile, carboxyl, amine, ammonium, amide, imide, N-methylol, isocyanate, hydroxyl, thiol, keto, carbonyl, acid anhydride, aceto acetonate, sulfonic acid groups, and salts thereof, herein also referred to as comonomer (iii) is different from biomonomer (i) and vinyl monomer (ii)

Examples of comonomer (iii) are (meth-)acrylamide and (meth-)acrylamide with N-substituted linear, cyclic or branched C₁- to C₂₀-alkyl groups, acrylonitrile, N-vinyl formamide, N-vinyl acetamide.

Preferred C₁- to C₂₀-alkyl groups of (meth-)acrylamide and N-substituted (meth-)acrylamides are methyl, ethyl, propyl, n-butyl, i-butyl, t-butyl, hexyl, cyclohexyl, 2-ethylhexyl, lauryl, stearyl, norbornyl, polyalkylene oxide and/or polyalkylene glycol groups, in particular methyl, butyl, 2-ethylhexyl groups.

Suitable comonomers (iii) are ethylenically unsaturated monocarboxylic and dicarboxylic acids and their anhydrides, preferably acrylic acid, methacrylic acid, itaconic acid, crotonic acid, fumaric acid and maleic acid, and maleic anhydride; ethylenically unsaturated carboxamides and carbonitriles, preferably acrylamide, methacrylamide, acrylamidoglycolic acid, and acrylonitrile; ethylenically unsaturated sulfonic acids and their salts, preferably vinyl sulfonic acid and 2-acrylamido-2-methylpropane sulfonic acid, styrene sulfonic acid, acrylic acid-sulfopropyl ester, itaconic acid-sulfopropyl ester, as well as in each case the ammonium, sodium, potassium and/or calcium salts. When monomers with carboxyl groups are used, it is advantageous when this portion is small. Alternatively, no monomers with carboxyl groups are used at all.

Other suitable comonomers (iii) are olefinically unsaturated monomers with a cationic functionality The cationic charge can be prepared either through protonation of amines, in which case it is easily removable in an alkaline medium, or it can for instance be formed through quaternisation of nitrogen atoms. Non-limiting examples of such monomers are amino(meth)acrylates, vinyl pyridines, alkylamino groups-containing vinyl ethers and/or esters, alkylamino groups-containing (meth)acrylates and/or (meth)acrylamides. Preferred cationic monomers are N,N-[(3-chloro-2-hydroxypropyl)-3-dimethylammonium propyl]-(meth)acryl-amide chloride, N-[3-dimethylamino)-propyl]-(meth)acrylamide hydrochloride, N-[3-(trimethylammonium)propyl]-(methacrylamide chloride, 2-hydroxy-3-(meth)-acryloxypropyl-trimethyl ammonium chloride, dimethyldiallyl ammonium chloride, aziridine ethyl(meth)acrylate, morpholinoethyl(meth)acrylate, trimethyl ammonium ethyl(meth)acrylate chloride, dimethylaminopropyl(meth)acrylate, 1,2,2,6,6-pentamethyl piperidinyl(meth)acrylate, aminopropyl vinyl ether, diethylaminopropyl ether, and t-butylaminoethyl(meth)acrylate.

The monomer selection and the selection of the weight fractions of the comonomers are made so that in general the resulting glass transition temperature, Tg, is from −50° C. to +50° C., preferably from −30° C. to +40° C. The glass transition temperature, Tg, of the polymers can be determined in a known manner by means of differential scanning calorimetry (DSC), in which case the midpoint temperature in accordance with ASTM D3418-82 has to be taken into account.

The Tg can also be calculated approximately in advance using the Fox equation. According to T. G. Fox, Bull. Am. Physics Soc. 1, 3, page 123 (1956): 1/Tg=x1/Tg1+x2/Tg2+ . . . +xn/Tgn, where xn represents the mass fraction (% by weight/100) of the monomer n and Tgn is the glass transition temperature, in Kelvins, of the homopolymer of the monomer n. Tg values for homopolymers are listed in e.g. Ullmann's Encyclopedia of Industrial Chemistry, VCH, Weinheim, Vol. A21 (1992), p. 169.

In yet another preferred embodiment, it is advantageous that the polymer of the invention has a minimum film formation temperature (MFFT) of below room temperature, typically at or below 20° C., more preferably at or below 10° C., and in particular at or below 5° C., wherein the MFFT is determined in accordance with DIN 53787.

In a preferred embodiment, the solids content of the emulsion/dispersion of the present invention is between 30 and 75 wt. %, even more preferably between 40 and 70 wt. %.

Further Process Steps and Additives

Preparation takes place by the emulsion or suspension polymerisation process. During the polymerisation process in one embodiment the polymerisation temperature is suitably from 40° C. to 140° C., preferably from 60° C. to 100° C. In embodiments where gaseous comonomers such as ethylene or vinyl chloride are copolymerised, it is also possible to operate under pressure, generally between 5 bar and 100 bar.

The polymerisation can be carried out in a batch, semi-batch or continuous polymerisation process. Where suitable, a seed polymer can be used which may contain biomonomer (i). In one embodiment, all monomers can be added as one or parallel monomer feeds. In another embodiment, the monomers can be added at different stages, which may lead—in particular if they have a different composition—to heterogeneous morphologies such as e.g. core-shell morphology. The biomonomer (i) can be part of all monomer feeds or of a selection of the monomer feeds employed. By making the right selections, the skilled person is well able to optimise the process to obtain a product giving well-rounded properties in the final application.

The polymerisation is initiated with the water-soluble or monomer-soluble initiators, or redox initiator combinations, that are customary for emulsion polymerisation and suspension polymerisation, respectively.

The group of suitable initiators includes thermal initiator systems, such as persulfates, for instance potassium, sodium and/or ammonium persulfate, water- and monomer-soluble azoinitiators, such as azobisisobutyronitrile, azobiscyanovaleric acid, as well as 2,2′-azobis(2-methylpropionamidine)dihydrochloride, redox-initiator systems consisting of oxidising agents, such as for instance hydrogen peroxide, t-butyl hydroperoxide, t-butyl peroxide, isopropylbenzene monohydroperoxide, cumene hydroperoxide, t-butyl peroxopivalate, dibenzoyl peroxide, bicyclohexyl peroxydicarbonate and dicetyl peroxydicarbonate, and reducing agents, such as for instance sodium, potassium, ammonium, sulfite and disulfite, sodium, potassium, and zinc formaldehyde sulfoxylate, primary, secondary, and tertiary amines with a molecular weight of preferably less than 1,000, such as tetraethylene pentamine, as well as ascorbic acid, with it being possible, if so desired, to use oxidising agents which can form free radicals by means of thermal decomposition as such, as well as catalytic initiator systems, such as for instance the system H₂O₂/Fe²⁺/H⁺. The content of initiators, based on the monomer content, preferably is between about 0.01 and 5 wt. %, in particular between about 0.1 and 3 wt. %.

Preferred oxidising agents are peroxides such as hydrogen peroxide or organic peroxides such as are also used for radical formation, such as for instance t-butyl hydroperoxide and/or peroxyacetic acid. But it is also possible to use persulfates such as for instance ammonium, sodium and/or potassium persulfate, percarbonates such as sodium and/or potassium percarbonate, borates such as for instance sodium and/or potassium borate, transition metals with high oxidation numbers such as for instance permanganates and/or dichromates, metal ions such as for instance Ce⁴⁺, Ag⁺, Cu²⁺, anions of halogen oxo-acids such as for instance bromates, halogens such as for instance chlorine, fluorine, bromine and/or iodine, hypochlorites such as for instance sodium and/or potassium hypochlorite, and/or ozone.

In order to control the molecular weight it is possible to use regulating substances, also called chain transfer agents, during the polymerisation. If regulators are used, they are normally used in amounts of from 0.01 to 5.0% by weight, based on the monomers to be polymerised, and they are metered in separately or else as a premix with reaction components. Examples of such substances are n-dodecyl mercaptan, tert-dodecyl mercaptan, mercaptopropionic acid, methyl mercapto propionate, isopropanol, and acetaldehyde. Preferably, no regulating substances are used.

In one embodiment, it is also possible for cationic and/or anionic colloids, which are only partially soluble or even fully insoluble in water, to be used. Such colloids, dispersions stabilised therewith, and redispersible polymer powders obtained therefrom are described int. al. in EP 1 098 916, EP 1 109 838, EP 1 102 793, and EP 1 923 405.

The mean particle size of the dispersion of the invention typically is from about 0.05 μm, preferably from about 0.1 μm, to about 5.0 μm, preferably to about 3.0 μm, with it also being possible to use emulsions having smaller and/or larger emulsion particles. The particle size is measured by means of light scattering and indicated as volumetric mean.

In this specification water-redispersible polymer powder stands for a powder wherein the primary particles are designed in such a manner that they keep their shape after they are dried, optionally with suitable adjuvants. This means that drying can be done while avoiding film formation.

In order to get redispersible polymer powders that do not form a film upon drying but are capable of film formation when used in their final application, several measures known to the person skilled in the art can be taken. These known measures include but are not limited to the addition of high-molecular weight stabilising colloids during and/or after the emulsion or suspension polymerisation.

Additionally, a skilled person will know that some drying methods are more appropriate to prevent the formation of a film upon drying than others and that the conditions during drying also assist in preventing the formation of a film when drying the redispersible polymer powder.

Another measure to prevent film formation in the powder state includes ensuring that the glass transition temperature of the primary particles obtained from emulsion or suspension polymerisation is not too low, since otherwise, despite the use of added stabilising colloids, coalescence and thus film formation will occur when making the powders, which has a distinct detrimental effect on redispersion. Thus it has been shown that the glass transition temperature for polymers in the form of redispersible polymer powders as a rule should not be lower than −30° C., preferably not lower than −20° C., and most preferably not lower than about −15° C., in order to obtain a polymer powder which is still readily redispersible in water, which can also be transported without any problem, and which can even be stored at +40° C.

In order to prepare the water-redispersible polymer powders, the aqueous dispersions are admixed if so desired with spraying aids and optionally further additives and then dried by means, for example, of fluidised bed drying, freeze drying, or spray drying. Preferably, the dispersions are spray dried.

Spray drying takes place in standard spray-drying units, it being possible for atomisation to take place by means of one-fluid, two-fluid or multifluid nozzles or with a rotating disk.

The exit temperature is generally chosen in the range from 45° C. to 120° C., preferably from 60° C. to 90° C., depending on the unit, on the Tg of the polymer. In general, the spraying aid is used in a total amount of from 3 to 30 wt. % , based on the solids of the dispersion.

In other words, the total amount of spraying aid prior to the drying operation should be from at least 3 to 30 wt. % , based on the polymer fraction; it is preferred to use from 5 to 20 wt. %, based on the polymer fraction.

Suitable spraying aids are partially hydrolysed polyvinyl alcohols; polyvinyl pyrrolidones; polysaccharides in water-soluble form such as starches (amylose and amylopectin), celluloses and their carboxymethyl, alkyl, hydroxyalkyl, alkylhydroxyalkyl derivatives, with the alkyl group preferably being a methyl, ethyl and/or propyl group and the hydroxyalkyl group preferably being a hydroxyethyl and/or hydroxypropyl group; proteins such as casein or caseinate, soya protein, gelatin; lignin sulfonates, synthetic polymers such as poly(meth)acrylic acid, copolymers of (meth)acrylates with carboxyl-functional comonomer units, poly(meth)acrylamide, polyvinyl sulfonic acids and their water-soluble copolymers; melamine formaldehyde sulfonates, naphthalene-formaldehyde sulfonates, and styrene-maleic acid and vinyl ether-maleic acid copolymers.

Preferably, partly hydrolysed polyvinyl alcohols and polysaccharides such as cellulose ethers, starches, and dextrines, are used as spraying aids.

At the spraying stage it has in many cases been found advantageous to include up to 1.5% by weight of antifoam, based on the base polymer.

In order to extend storage life by improving the blocking stability, especially in the case of powders having a low glass transition temperature, the powder obtained can be provided with an antiblocking (anticaking) agent, preferably up to 50 wt. %, based on the overall weight of the polymeric constituents.

Examples of antiblocking agents are Ca and/or Mg carbonate, talc, gypsum, silica, kaolins, and silicates having particle sizes preferably in the range from 10 nm to 100 microns, preferably 50 nm to 50 microns.

In order to improve the performance properties, further additives can be added at the spraying stage. Examples of further constituents of dispersion powder compositions present in preferred embodiments are pigments, fillers, foam stabilisers, and hydrophobising agents, defoamers, superplasticisers, coalescing agents, and additives which reduce efflorence and shrinkage of mortars.

The drying to obtain the polymer powder according to the invention can take place, optionally after the addition of further water-soluble polymers and/or further additives, by means which avoid or at least minimise film formation of the emulsion. Preferred such means are spray drying, including pulse combustion spray drying, freeze drying, fluidised bed drying, drum drying or flash drying, in which case spray drying is particularly preferred and the spraying can take place for instance by means of a spraying wheel, one-component or multi-component nozzle. If necessary, the mixture to be dried can still be diluted with water, in order to achieve a suitable viscosity for the drying. The drying temperature in principle has no real limits. In particular because of safety-related considerations, however, it should not, as a rule, exceed about 200° C., in particular about 175° C. In order to attain sufficiently efficient drying, temperatures of the inlet air of about 110° C. or higher, in particular of about 120° C. or higher, are preferred.

The mean particle size of the polymer powder after drying in one embodiment amounts to at least about 10 μm or more, preferably about 30 μm or more, in particular about 50 μm or more. In addition, it is often useful when the mean particle size is at most about 2 mm or less, preferably about 1 mm or less, in particular about 0.5 mm or less, and the polymer powder is easily pourable as well as block and storage stable. The particle size of the powder particles is preferably measured by means of light scattering, in which case the volumetric mean is also decisive.

The redispersible polymer powder according to the invention can also contain further additives. Preferred are water-soluble polymers such as polyvinyl alcohol, thickening agents, polycarboxylates, polyacrylamides, softeners, preservative agents such as biocides, herbicides, algicides and/or fungicides, anti-foaming agents, anti-oxidants, preservatives, such as preservatives against oxide, heat, ozone, light, fatigue and/or hydrolysis, additives for the reduction of sedimentation and/or bleeding, surface-active compounds such as powdery and/or liquid wetting agents, anti-foaming agents and/or tensides, alkyl, hydroxyalkyl and/or alkylhydroxyalkyl polysaccharide ethers such as cellulose ethers, starch ethers and/or guar ethers, with the alkyl and hydroxyalkyl group typically being a C₁- to C₄-group, dispersing agents, further rheology control additives such as for instance casein and/or thickening agents, agents to control the hydration of minerally setting systems, in particular setting accelerators, solidification accelerators and/or setting retarders, air-entraining agents, hydrophobic agents and/or additives for reduction of the water absorption capacity, in particular based on silanes, siloxanes, silicones, metal soaps, fatty acids and/or fatty acid esters, additives for reduction of the water absorption capacity, in particular based on silanes, siloxanes, silicones, metal soaps, fatty acids and/or fatty acid esters, additives for the reduction of shrinkage and/or efflorescence, such as for instance compounds based on natural resins, in particular colophonium and/or the derivatives thereof, as well as quarternary organic ammonium compounds, fibres such as cellulose fibres, additives for the entry of air voids, water retention agents, colour pigments as well as powders which have an alkaline reaction with water, in particular oxides and/or hydroxides of alkali and/or alkaline earth salts.

Quite especially preferred additives are polysaccharide ethers, hydrophobic agents, in particular silanes, silane esters, siloxanes, fatty acids and/or fatty acid esters, water retention agents as well as additives to control the rheology, hydration, shrinkage and/or the reduction of efflorescence.

The content of these additives can be very low for for instance low-molecular surface-active substances and be in the range of about 0.01 wt. % or more, in particular about 0.1 wt. % and more, based on the dry content of the polymer powder. As a rule, it is not more than about 50 wt. %, in particular not more than about 30 wt. %, based on the dry content of the polymer powder. The addition of this additive can take place before, during and/or after the drying.

In a preferred embodiment, the water-redispersible polymer powder according to the invention contains up to about 90 wt. %, preferably about 5 to 80 wt. %, in particular about 10 to 70 wt. %, of at least one water-insoluble, synthetic polymer, about 2 to 50 wt. %, preferably about 3 to 30 wt. %, in particular about 5 to 20 wt. %, of at least one stabiliser, about 2 to 50 wt. %, preferably about 5 to 40 wt. %, in particular about 10 to 30 wt. %, of at least one filler and/or anti-caking agent, as well as optionally further additives, with the specifications in wt. % being based on the total weight of the polymer powder composition and in all cases adding up to 100 wt. %.

The emulsion and powder of the invention preferably contain a content of volatile organic compounds (VOC-content for short) of less than about 2,000 ppm, preferably of less than about 1,000 ppm, in particular of less than about 500 ppm, based on the dry content of the powder. According to the invention, the VOCs are determined in accordance with the Directive of the European Union 2004/42/CE, which classifies as VOC each organic compound which at a standard pressure of 101.3 kPa has a boiling point of 250° C. or lower. When the VOC-content prior to drying is too high, it can be reduced using common techniques such as for instance vapour and/or vacuum distillation and/or reacting off residual monomers.

Building Material Composition

As indicated above, it was found that the powder and dispersion of the present invention are particularly suitable for improving the freeze-thaw stability and/or hydrophobising and/or reducing the water absorption of building material compositions which are mixed with water and cured. Consequently, the present invention also relates to the use of the dispersible or redispersible polymer powder as an additive in building material compositions, preferably in building material compositions in powder form, and to building material compositions containing the polymer powder, in particular building material compositions in powder form.

Building material compositions are well known to the person skilled in the art and include in particular mortars, concrete, plasters, coating systems, and building adhesives. The building material compositions generally contain one or several binders. Quite especially preferred are compositions in the form of mixtures, in particular dry mortar mixtures, which are mixed with water only a short time before application. As one-component products, they can thus be easily transported and stored.

The building material compositions of the present invention in one embodiment contain, based on the dry content of the building material composition, at least about 0.1 wt. %, preferably at least about 0.5 wt. %, in particular at least about 1.0 wt. %, and/or at most about 50 wt. %, preferably at most about 40 wt. %, in particular at most about 30 wt. %, of the polymer powder according to the invention.

In one preferred embodiment, the building material compositions contain at least one minerally setting binder. In another preferred embodiment, the building material compositions contain no or less than 5 wt. %, preferably less than 2.5 wt. %, of a minerally setting binder.

By mineral binders are meant in the meaning of the invention, binders which as a rule are in powder form and in particular consist of at least a) one hydraulically setting binder, b) one latent hydraulic binder and/or c) one non-hydraulic binder which reacts under the influence of air and water.

As hydraulically setting binders can be used cement, in particular Portland cement, for instance in accordance with EN 196 CEM I, II, III, IV, and V, high-alumina cement and/or gypsum, by which are meant in the meaning of this invention in particular calcium sulfate in the form of α- and/or β-semihydrate and/or anhydrite of form I, II and/or III. As latent hydraulic binders pozzolanes such as metakaolin, calcium metasilicate and/or vulcanic slag, vulcanic tuff, trass, fly ash, acid blast-furnace slag and/or silica dust can be used, which react hydraulically in combination with a calcium source such as calcium hydroxide and/or cement. As non-hydraulic binder can be used in particular lime, mostly in the form of calcium hydroxide and/or calcium oxide. Preferred above all are pure Portland cement-based construction material compounds, a mixture of Portland cement, high-alumina cement, and calcium sulfate, as well as gypsum-based building material compositions, with it being possible in each case, if so desired, to also add latent hydraulic and/or non-hydraulic binders.

The dry mortar mixtures according to the invention can be formulated for instance as coating or composite mortars, thermal insulation mortars, sealing compounds, gypsum and/or lime and/or cement plasters, repair mortars, tile grouts, ceramic tile adhesives, plywood mortars, bonding mortars, cement primers, cementitious coatings for concrete, powder paints, parquet adhesives, self-levelling floor screeds, smoothing and/or trowelling compounds. Due to the hydrophobicity and low water absorption achieved by the polymer powder according to the invention, such mortars can be used outdoors as well as indoors.

The building material compositions of the present invention can also contain one or more filler materials like fillers and/or aggregates such as quartzitic and/or carbonatic sands and/or powders such as for instance quartz sand and/or limestone powder, carbonates, silicates, chalks, layered silicates, precipitated silicas, light-weight fillers such as for instance hollow microspheres of glass, polymers such as polystyrene spheres, alumosilicates, silica, aluminium-silica, calcium-silicate hydrate, silicon dioxide, aluminium-silicate, magnesium-silicate, aluminium-silicate hydrate, calcium-aluminium-silicate, calcium-silicate hydrate, aluminium-iron-magnesium-silicate, calcium-metasilicate, clays such as bentonite and/or vulcanic slag, as well as pozzolanes such as metakaolin and/or latently hydraulic components, in which case the fillers and/or light-weight fillers can also have a natural or artificially generated colour.

The building material composition can in one embodiment contain further additives. As to the nature of the further additives no real restrictions are imposed, as long as they do not enter into any undesired reactions. Often they have an important function in mortars containing no or less than 5 wt. % of a minerally setting binder. If the additives are themselves powdery, they can for instance be easily added to the redispersible polymer powder. If they are liquid, the addition preferably takes place before and/or during the drying step in the preparation of the powder according to the invention. In this way, for instance, also further organic polymers can be added which are water-soluble and/or water-insoluble.

Preferred further additives are powdery and/or liquid antifoaming agents, wetting agents, alkyl, hydroxyalkyl and/or alkylhydroxyalkyl polysaccharide ethers such as cellulose ethers, starch ethers and/or guar ethers, with the alkyl and hydroxyalkyl group typically being a C₁- to C₄-group, synthetic polysaccharides such as anionic, nonionic or cationic heteropolysaccharides, in particular xanthan gum or welan gum, cellulose fibres, dispersing agents, rheology control additives, in particular liquefiers, thickeners and/or casein, hydration control additives, in particular setting accelerators, solidification accelerators and/or setting inhibitors, air voids builders, polycarboxylates, polycarboxylate ethers, polyacrylamides, wholly and/or partially saponified, and optionally modified, polyvinyl alcohols, polyvinyl pyrrolidones, polyalkylene oxides and polyalkylene glycols, with the alkylene group typically being a C₂- and/or C₃-group. Included among these are also block copolymerisates, dispersions, and water-redispersible dispersion powders, also called redispersible polymer powders, based on water-insoluble film-forming polymers such as for instance based on vinyl acetate, ethylene-vinyl acetate, ethylene-vinyl acetate-vinyl versatate, ethylene-vinyl acetate-(meth)acrylate, ethylene-vinyl acetate-vinyl chloride, vinyl acetate-vinyl versatate, vinyl acetate-vinyl versatate-(meth)acrylate, vinyl versatate-(meth)acrylate, pure (meth)acrylate, styrene-acrylate and/or styrene-butadiene, wherein vinyl versatate preferably is a C4- to C12-vinylester, and the polymerisates can contain about 0-50 wt. %, in particular about 0-30 wt. %, and quite especially preferably about 0-10 wt. % of further monomers, in particular monomers with functional groups, further additives for hydrophobising and/or for reducing the water absorption capacity, in particular based on silanes, siloxanes, silicones, metal soaps, fatty acids and/or fatty acid esters, additives for reducing blistering such as for instance compounds based on natural resins, in particular colophony and/or its derivatives, fibres such as cellulose fibres, dispersing agents, additives for filling air voids, water retention agents and/or pigments.

The building material compositions in which the amount of cement is zero or less than 5 wt. %, based on the total weight of the final formulation in the dry and uncured form, preferably are building material formulations with or without minerally setting components. By this the skilled person means in particular mortar, concrete, plasters, coating systems, and construction adhesives. These formulations typically contain one or more binders.

In a preferred embodiment, the redispersible polymer powder is used in gypsum-based formulations. Such formulations as a rule have a proportion of gypsum of at least 70 wt. %, in particular of at least 90 wt. %, calculated on the overall proportion of mineral binder, with this being, calculated on the dry content of the formulation, at least 15 wt. %, preferably at least 20 wt. %, in particular at least 35 wt. %.

In another preferred embodiment, the mass containing no or less than 5 wt. % cement is a so-called cement-free and gypsum-free mortar, but it contains another mineral binder, in particular a latent hydraulic binder, although also other hydraulic and/or non-hydraulic binders can be used.

In yet another preferred embodiment, the composition contains no mineral binder or less than 5 wt. %, preferably less than 3 wt. %, in particular less than 1 wt. % thereof, calculated on the dry content of the formulation. Besides the mineral binder, both embodiments can also additionally contain non-mineral binders.

In the context of the invention, non-mineral binders are solid materials as well as high- and/or low-viscous liquids. Preferred are water-soluble and/or water-dispersible polymers such as film-forming dispersions and/or redispersible polymer powders based on emulsion polymers, as well as epoxide resins.

Often, but not as a rule, the dry mortar formulation contains at least one minerally setting binder, which is added only in very small amounts, or else as main component, to the dry mortar formulation.

In one preferred embodiment, the dry mortar formulation according to the invention is a gypsum dry mortar, wherein the proportion of gypsum, calculated on the dry mortar, is at least about 15 wt. %, preferably at least about 20 wt. %, and in particular at least about 35 wt. %, based on the total weight of the dry, uncured mortar formulation.

Such dry mortar formulations preferably contain about 15 to 75 wt. %, in particular about 20 to 70 wt. %, quite especially preferably about 30 to 65 wt. %, of at least one type of gypsum, about 20 to 80 wt. %, in particular about 25 to 75 wt. %, quite especially preferably about 30 to 65 wt. %, of at least one filler and/or aggregate, about 0.01 to 5 wt. %, in particular 0.05 to 3 wt. %, quite especially preferably about 0.1 to 2 wt. %, of the powder, granulate and/or flakes to be used according to the invention, as well as up to about 5 wt. %, in particular 3 wt. % of further additives such as for instance polysaccharide ethers such as cellulose ethers and the alkyl and/or hydroxyalkyl derivatives thereof, retardants and/or accelerators, surface-active substances such as defoamers and/or wetting agents and water-redispersible polymer powders, also called redispersion powders, and further additives known to the skilled person. All amounts are based on the total weight of the final formulation in the dry and uncured form.

In another embodiment, the dry mortar formulation contains no or less than about 5 wt. %, in particular less than about 2.5 wt. %, calculated on the dry content of the dry, uncured mortar formulation, of a minerally, in particular hydraulically, setting binder.

Such dry mortar formulations preferably contain about 50 to 99.9 wt. %, in particular about 60 to 95 wt. % of at least one filler and/or aggregate, about 0.01 to 5 wt. %, in particular 0.05 to 3 wt. %, quite especially preferably about 0.1 to 2 wt. %, of the powder, granulate and/or flakes to be used according to the invention, about 3 to 40 wt. %, in particular about 5 to 30 wt. % of water-redispersible polymer powder, as well as up to about 15 wt. %, in particular up to about 10 wt. % of further additives such as for instance polysaccharide ethers such as cellulose ethers and the alkyl and/or hydroxyalkyl derivatives thereof, cellulose fibres, retardants and/or accelerators, surface-active substances such as defoamers and/or wetting agents, optionally minerally setting binders, as well as further additives known to the skilled person. All amounts are based on the total weight of the final formulation in the dry, uncured form.

The dry mortar formulations according to the invention can be formulated for instance as coating or composite mortar, mixtures to make plaster boards, thermal insulation mortar, sealing compounds, gypsum and/or lime and/or cement plasters, repair mortar, joint adhesives, tile adhesives, in particular ceramic tile adhesives, plywood-mortar, mortar for minerally bonding agents, cement primers, concrete coating mortar, powder coatings, parquet adhesives, skim coats, levelling compounds and/or screeds. Thanks to the hydrophobicity and low water absorption obtained by the addition of the solid according to the invention, such mortars can be used in the outdoor as well as the indoor area. Preferably, they are used in drywall installation, in plastering, in the handyman and do-it-yourself area, and have been formulated as plaster glue, smoothing mortar, finish mortar, joint filler, joint sealer, tile adhesive, stucco work and/or moulding plaster composition, levelling compound, gypsum screed, gypsum, gypsum-lime and/or synthetic resin plaster, pasty adhesive and/or water-based coating or are used for producing gypsum plaster boards.

The inventive dry mortar formulation containing no or less than 5 wt. % cement, based on the total weight of the final formulation in the dry and uncured form obtained by dry mixing the mortar components with the solid, in particular with the inventive powder, can be further processed by mixing the obtained dry mortar formulation with water and applying it onto a substrate or casting it into a mould, and allowing it to dry. The drying can typically occur at ambient conditions and/or at elevated temperatures. The latter is particularly preferred when moulded articles are manufactured.

Alternatively, it is also possible for the solid to be added as a separate component directly before, during and/or after the mixing of the dry mortar formulation that does not yet contain the solid with water. In another embodiment, the solid is first dissolved, dispersed and/or redispersed in water, e.g., in the mixing water, and mixed with the dry mortar formulation by this method. At all times, it must be ensured that the amount of cement in the final formulation is zero or less than 5 wt. %, based on the total weight of the final formulation in the dry and uncured form.

Since the product of the invention may be a redispersible polymer powder, it is possible for it to be worked into a dry mixture already at the factory, which makes possible exact dosing and a homogeneous distribution and makes its preparation particularly easy and economical. For use this dry mixture then only has to be mixed with the appropriate amount of water and applied, which brings many advantages with it, such as for instance easy handling, simplified logistics and/or resistance to freeze-thaw.

The invention finally provides a process for improving the freeze-thaw stability and/or for hydrophobising, in particular mass hydrophobising, cured building material compositions wherein the building material compositions containing the polymer powder of the invention are mixed with water, blended, applied to a substrate, and subsequently dried, in which process the drying can take place under ambient conditions and by means of chemical binding of the water and/or by removing the water by means of evaporation and/or absorption through the substrate. In that case it is of great advantage that no additional curing step and/or curing aid such as for instance a catalyst is needed. By ambient conditions are meant the conditions provided by the surroundings, without for instance additional heat, vapour and/or radiation being supplied.

In the process to improve the freeze-thaw stability and/or to hydrophobise cured building material compositions of the invention, the polymer powder can either be worked into the building material composition and/or used for surface treatment of the building material composition. When it is worked into the building material composition, the whole building material composition is hydrophobised, even when the surface is damaged. In this case the term mass hydrophobising is used. The polymer powder according to the invention in the meaning of the invention also leads to strongly reduced water absorption of the building material composition, even when it has an alkaline or neutral pH-value.

In another process for making hydrophobic building compounds containing no or less than 5 wt. % cement, the solid according to the invention, preferably in the form of a powder, granulate and/or flake, is applied onto the surface of building compounds containing no or less than 5 wt. % cement as an aqueous solution, dispersion and/or redispersion and is allowed to dry.

Non-limiting examples of substrates on which the building material composition can be applied are mineral building materials, bricks, component parts and/or constructions, mineral construction materials, such as lime sandstone, granite, lime, gypsum, marble, perlite, porous and non-porous tiles, natural stone, screed, clay articles but also artificial stone, masonries, facades, roofs, bricks and/or terracotta.

Suitable substrates are most typically a wall, floor or grout, e.g. made of concrete, bricks, wood, expanded polystyrene, plaster board, or ceramic tile.

The invention is further elucidated with reference to the following examples. Unless indicated otherwise, the tests are carried out at a temperature of 23° C. and a relative humidity of 50%.

### EXAMPLES

Abbreviations

PvOH 4/88: Polyvinyl alcohol having a degree of hydrolysis of 88% and a viscosity of 4 mPas (in the form of a 4% aqueous solution)

PvOH 18/88: Polyvinyl alcohol having a degree of hydrolysis of 88% and a viscosity of 18 mPas (in the form of a 4% aqueous solution)

PvOH 40/88: Polyvinyl alcohol having a degree of hydrolysis of 88% and a viscosity of 40 mPas (in the form of a 4% aqueous solution)

Wako V-50: 2,2′-Azobis(2-amidinopropane)dihydrochloride

VAc: Vinyl acetate

Rongalit C: sodium formaldehyde sulfoxylate

VeoVa10: vinyl ester of Versatic 10, trademark of Hexion Specialty Chemicals

Preparation of Biomonomer B-1.

To a 3-litre round bottomed flask fitted with a water cooled condenser, means to provide a nitrogen blanket, and an anchor stirrer operating at 75 rpm were added 1707.8 g soybean oil and 286.1 g maleic anhydride. The mixture was heated to 100° C. and 2.5 g iodine were added. The temperature was raised to 200° C. and held there for 30 minutes and then increased to 220° C. After 4 hours the mixture was cooled to room temperature and filtered through lambswool.

To a 700 ml round bottomed flask fitted with a water cooled condenser, means to provide a nitrogen blanket, and an anchor stirrer operating at 75 rpm were added 359.32 g of the maleinised soybean oil described above. The mixture was heated to 100° C. and 1.20 g phenothiazine were added. The mixture was then heated to 200° C. and 30.42 g hydroxyethyl acrylate were fed in via a dropping funnel over 15 minutes. The mixture was held at 200° C. for 50 minutes, then cooled down to approximately 70° C. and filtered through lambswool.

Preparation of Emulsions and Powders

### Example 1

### Preparation of Emulsion E-1

47 g of PvOH 4/88 and 16 g of PvOH 18/88 dissolved in 689 g water were placed in a 2-litre glass reactor equipped with a stirrer and a temperature control device. The pH value was adjusted with 1.25 g of sodium bicarbonate. That solution was thermostated to 73° C. 0.15 g of Wako V-50 was added to this presolution. Subsequently, 42 g of VAc were added continuously over 40 minutes. Next, a monomer mixture consisting of 345 g of VAc and 68 g of Biomonomer B-1 was added continuously during 180 minutes, and parallel thereto 1.2 g of Wako V-50 dissolved in 80 g water were dosed to the reactor during 210 minutes. The reaction temperature increased to 83° C. Half an hour after commencement of the monomer addition, 0.35 g tert-butyl hydroperoxide (as 70% solution in water) and 0.15 g of Rongalit C were added and after another 15 minutes the reaction mixture was cooled down, resulting in a stable dispersion with a solids content of 40%.

### Example 2

### Preparation of Emulsion E-2

36.5 g of PvOH 4/88 and 5.2 g of PvOH 18/88 dissolved in 473.3 g water were placed in a 2-litre glass reactor equipped with a stirrer and a temperature control device. The pH value was adjusted with 1.25 g of sodium bicarbonate. That solution was thermostated to 73° C. 0.15 g of Wako V-50 was added to this presolution. Subsequently, 85.6 g of VAc were added continuously over 40 minutes. Next, a monomer mixture consisting of 167.4 g of VAc and 104 g of Biomonomer B-1 was added continuously during 240 minutes, and parallel thereto 5.4 g of Wako V-50 dissolved in 80 g water were dosed to the reactor during 270 minutes. The reaction temperature increased to 83° C. Half an hour after commencement of the monomer addition, 0.35 g tert-butyl hydroperoxide (as 70% solution in water) and 0.15 g of Rongalit C were added and after another 15 minutes the reaction mixture was cooled down, resulting in a stable dispersion with a solids content of 42%.

### Example 3

### Preparation of Emulsion E-3

20 g of PvOH 4/88 and 22 g of PvOH 40/88 dissolved in 533 g water were placed in a 2-litre glass reactor equipped with a stirrer and a temperature control device. The pH value was adjusted with 1 g of sodium bicarbonate. That solution was thermostated to 84° C. 0.2 g of Wako V-50 was added to this presolution. Subsequently, a mixture consisting of 257 g of Vac, 37 g of VeoVa10, and 73 g of Biomonomer B-1 was added continuously over 220 minutes. Parallel thereto a solution of 1.4 g Wako V-50 dissolved in 80 g water was added over 235 minutes. The reaction temperature increased to 90-92° C. Half an hour after commencement of the monomer addition, 0.60 g tert-butyl hydroperoxide (as 70% solution in water), 0.27 g of Rongalit C dissolved in 2 g water, and 2.7 g of VAC were added and after another 30 minutes the reaction mixture was cooled down, resulting in a stable dispersion with a solids content of 40%.

### Example 4

### Spray Drying of Powders P 1-3

500 g of each of the emulsions described in Examples 1-3 were mixed with 40 g of a 25 wt. % solution of PvOH 4/88 in water. The mixture was spray dried without further additives through conventional spray drying with an inlet temperature of 125° C. to a white, free flowing powder with good yield. Finally, 0.5 wt. % of a standard silica and 18 wt. % of a standard carbonate were added to the resulting powders P1-3.

### Reference Example 1

### Powder P-4

Powder P-4 is a commercially available, water-redispersible polymer powder based on a polyvinyl alcohol-stabilised vinyl acetate-VeoVa10 dispersion with 25 wt. % VeoVa10 having an MFFT of +5° C.

### Reference Example 2

### Powder P-5

Powder P-5 is a commercially available, strongly hydrophobic, water-repellent water-redispersible polymer powder based on a polyvinyl alcohol-stabilised vinyl acetate-VeoVa10 dispersion with 60 wt. % VeoVa10 having a MFFT of 0° C.

### Reference Example 3

### Powder P-6

Powder P-5 is a commercially available, water-redispersible polymer powder based on a polyvinyl alcohol-stabilised vinyl acetate, VeoVa10, and ethylene dispersion with 11 wt. % VeoVa10 having a MFFT of +5° C.

### Reference Example 4

### Powder P-7

Powder P-5 is a commercially available, water-redispersible polymer powder based on a polyvinyl alcohol-stabilised copolymer of vinyl acetate and ethylene having a MFFT of +3° C.

Preparation of Dry Mortar Master Batches

### Example 5

### Preparation of Cement-Based Dry Mortar Master Batch TM-1

5 kg of a cement-based dry mortar master batch TM-1 were prepared, consisting of 340 parts by weight of a commercially available Portland cement CEM I 42.5, 598 parts by weight of a quartz sand (0.1-0.6 mm), 30 parts by weight of hydrated lime, and 2 parts by weight of a commercially available cellulose ether (methylhydroxyethyl cellulose), with a viscosity of 3,000-7,000 mPas (Brookfield RV viscosity measured at 20 rpm as a 1.9 wt. % solution in water at 20° C.), in which process the components were mixed in a 10 l vessel with a FESTO stirrer until a homogeneous dry mortar master batch was obtained.

### Example 6

### Preparation of Cement-Based Dry Mortar Master Batch TM-2

5 kg of a cement-based dry mortar master batch TM-2 were prepared, consisting of 330 parts by weight of a commercially available Portland cement CEM I 52.5, 270 parts by weight of a quartz sand (0.08-0.2 mm), 337 parts by weight of a commercially available calcium carbonate (Durcal 65), 30 parts by weight of hydrated lime, and 3 parts by weight of a commercially available cellulose ether (methylhydroxyethyl cellulose) with a viscosity of 3,000-7,000 mPas (Brookfield RV viscosity measured at 20 rpm as a 1.9 wt. % solution in water at 20° C.), in which process the components were mixed in a 10 l vessel with a FESTO stirrer until a homogeneous dry mortar master batch was obtained.

### Example 7

### Preparation of Cement-Based Dry Mortar Master Batch TM-3

5 kg of a cement-based dry mortar master batch TM-3 were prepared, consisting of 400 parts by weight of a commercially available Portland cement CEM I 52.5, 178 parts by weight of a quartz sand (0.1-0.3 mm), 320 parts by weight of another quartz sand (0.1-0.6 mm), 70 parts by weight of a commercially available calcium carbonate (Durcal 65), 3 parts by weight of a commercially available cellulose ether (methylhydroxyethyl cellulose) with a viscosity of 3,000-7,000 mPas (Brookfield RV viscosity measured at 20 rpm as a 1.9 wt. % solution in water at 20° C.), and 7 parts by weight of calcium formiate, in which process the components were mixed in a 10 l vessel with a FESTO stirrer until a homogeneous dry mortar master batch was obtained.

Application-Specific testing

Preparation of the Mortar Premix:

The amounts indicated in Tables 1 and 2 (parts by weight) of the dry mixture in question were first of all mixed dry with the redispersible polymer powders according to the invention. Subsequently, the respective mixtures were stirred for 60 seconds with the amount of water indicated in the Tables, based on 100 parts of dry mortar formulation, with a 60 mm propeller stirrer at a rate of 800 rpm, with the mixing water being introduced. After a maturing time of 3 minutes the mortar was briefly stirred again by hand and applied. It is noted that all powders could be readily mixed with the other mortars constituents. Upon water addition, the powders according to the invention revealed an excellent wettability and miscibility, while their hydrophobic character is revealed only upon curing of the mortar.

### Example 8

### Determination of Hydrophobicity by Means of the Water Drop Method

The ready mixture was applied with the aid of spacers in a layer thickness of 5 mm on a cement fibre board, with the mortar in the lower part being drawn away without spacers to grain size (zero coating). The prepared samples were next stored for 1 day at 23° C. and 50% relative humidity. On the two mortar surfaces (5 mm and zero coating) of the respective samples 0.5 ml water each was applied with a pipette, with the time being measured until the water drops applied were fully absorbed by the mortar substrate.

TABLE 1
Determination of the hydrophobicity of the cement-based dry
mortar master batch TM-1 mixed with different additives in
powder form (indication in wt. %) and with 23 wt. % mixing
water (on 100 wt. % dry mortar formulation)

| | Experiment No. | | | | | |
|---|---|---|---|---|---|---|
| | 1.1 | 1.2 | 1.3 | 1.4 | 1.5 | |
| TM-1 | 96% | 96% | 96% | 96% | 96% | |
| Powder P-4 (Ref.) | 4% | | | | | |
| Powder P-5 (Ref.) | | 4% | | | | |
| Powder P-1 | | | 4% | | | |
| Powder P-2 | | | | 4% | | |
| Powder P-3 | | | | | 4% | |
| VeoVa10^{a)} | 25% | 60% | | | 10% | |
| Biomonomer B-1^{b)} | | | 15% | 29% | 20% | |
| 5 mm - layer | 15 min. | 90 min. | 30 min. | 85 min. | >120 | min.^{c)} |
| zero coating | 3 min. | 75 min. | 20 min. | 70 min. | 100 | min. |

^{a)}The amount of hydrophobic monomer (VeoVa10) used, based on the total amount of monomers being copolymerised (in wt. %)
^{b)}The amount of biomonomer B-1 used, based on the total amount of monomers being copolymerised (in wt. %)
^{c)}The water drop was still visible on the mortar surface even after 2 hours.

The results in Table 1 clearly show that with the powders according to the invention a cement-based dry mortar mixture can be formulated which shows a comparable hydrophobicity in the applied and cured state at a significantly lower level of hydrophobic monomer. Moreover, a clear synergistic effect can be observed when combining Biomonomer B-1 with a hydrophobic monomer (VeoVa10). Furthermore, the cured mortar samples also impart an excellent hydrophobic character to the damaged surface, thus revealing a good mass hydrophobisation. Additionally, the samples adhere well to the substrate and have good cohesion characteristics.

### Example 9

### Determination of the Water Absorption of a Dry Mortar

The ready mixture was applied into a plastic cylinder with a diameter of 8 cm and a height of 2 cm, which was put onto a plastic foil. The specimen was cured for 1 day at room temperature and then stripped from the plastic cylinder. The stripped specimen was further stored for 13 days at 23° C. and 50% relative humidity.

After storage was completed, the samples were weighed (G0) and immersed in a container with pure tap water in such a way that all parts of the specimen were fully covered with water. After 24 hours of storage in water the samples were taken out of the water, carefully dried, and weighed again (G24). From the averaged weights G0 and G24 the water uptake coefficient after 24 hours can be calculated as follows:

Water uptake coefficient w [kg/m²t^{0.5}]=G24−G0 [kg]/0.0151 m²×(t₂₄^{0.5}−t_{0.05})[h]

TABLE 2
Determination of the water uptake coefficient after 24 h of the
cement-based dry mortar master batch TM-2 mixed with different
additives in powder form (indication in wt. %) and with 27 wt. %
mixing water (on 100 wt. % dry mortar formulation)

| | Experiment No. | | | | |
|---|---|---|---|---|---|
| | 2.1 | 2.2 | 2.3 | 2.4 | 2.5 |
| TM-2 | 96% | 96% | 96% | 96% | 96% |
| Powder P-4 (Ref.) | 4% | | | | |
| Powder P-5 (Ref.) | | 4% | | | |
| Powder P-1 | | | 4% | | |
| Powder P-2 | | | | 4% | |
| Powder P-3 | | | | | 4% |
| VeoVa10^{a)} | 25% | 60% | | | 10% |
| Biomonomer B-1^{b)} | | | 15% | 29% | 20% |
| W (24 h) [kg/m²t^{0.5}] | 0.377 | 0.093 | 0.335 | 0.103 | 0.085 |

^{a)}See Table 1
^{b)}See Table 1

The results in Table 2 clearly show that with the powders according to the invention a cement-based dry mortar mixture can be formulated which shows a reduced water uptake in the applied and cured state at a significantly lower level of hydrophobic monomer. Again a synergistic effect can be observed when combining Biomonomer B-1 with a hydrophobic monomer (VeoVa10). Furthermore, the cured mortar samples also impart an excellent hydrophobic character to the damaged surface, thus revealing a good mass hydrophobisation. Additionally, the samples adhere well to the substrate and have good cohesion characteristics.

Hence, the use of biomonomer (i) instead of—or in addition to—hydrophobic monomer makes it possible to achieve the same degree of mortar hydrophobicity with a lower amount of biomonomer versus hydrophobic monomer. Alternatively, an increase in the mortar hydrophobicity can be obtained by exchanging all or part of the hydrophobic monomer for the same amount of biomonomer.

### Example 10

### Determination of Tensile Adhesion Strength for Cementitious Adhesives

The ready mixture was applied according to European Standard EN 1348. A thin layer of the adhesive is applied to a concrete slab substrate with a straight edge trowel, followed by a thicker layer of adhesive which is combed with a notched trowel having 6 mm×6 mm notches at 12 mm centres. The trowel shall be held at an angle of approximately 60° to the substrate.

After 5 minutes 6 vitrified tiles (200 g, 10×10 cm) are placed on the adhesive, each tile is loaded with a weight of 2 kg for 30 seconds.

The adhesion test is performed after different storage conditions:

Dry storage (D): Specimens are stored for 28 days at standard conditions (23° C./50% r.h.)

Freeze-Thaw storage (F): Specimens are stored for 7 days at standard conditions, and afterwards immersed in water for 21 days before carrying out 25 freeze-thaw cycles.

One day before the storage cycles are finished, pull-head plates are bonded to the tile with a suitably high strength adhesive (e.g epoxide). The specimens are subjected to a direct pull tensile force test in a tensile testing machine capable of applying the load to the pull-head plate at the rate of 250+−50 N/s through a suitable fitting that does not exert any bending force.

The individual tensile adhesion strength is determined using the following formula:

Aₛ=L/A

With:

Aₛ: Individual tensile adhesion strength in newtons per square millimeter

L: Total load in newtons

A: Bonding area in square millimeters (the total bonding area per tile is 2500 mm²)

The tensile adhesion strength for each set of conditions as given below was determined as follows:
Discarding the values falling out of the range of +−10% from the mean value
If five or more than five values remain, determine new mean value
If less than five values remain, repeat the test

TABLE 3
Determination of the tensile adhesion strength after dry storage (D)
and freeze-thaw storage (F) of the cement-based dry mortar master
batch TM-3 mixed with different additives in powder form
(indication in wt. %) and with 23 wt. % mixing water
(on 100 wt. % dry mortar formulation)

| | Experiment No. | | |
|---|---|---|---|
| | 3.1 | 3.2 | 3.3 |
| TM-3 | 98% | 98% | 98% |
| Powder P-6 (Ref.)^{a)} | 2% | | |
| Powder P-7 (Ref.)^{b)} | | 2% | |
| Powder P-1^{c)} | | | 2% |
| D [N/mm²] | 1.80 | 1.82 | 1.94 |
| F [N/mm²] | 1.38 | 1.07 | 2.03 |

^{a)}The amount of VeoVa10 used in Reference Powder P-6 is 11 wt. %, based on the total amount of monomers being copolymerised.
^{b)}Reference Powder P-7 does not contain a hydrophobic monomer.
^{c)}The amount of Biomonomer B-1 used in Powder P-1 is 15 wt. %, based on the total amount of monomers being copolymerised.

The results in Table 3 clearly show that with the powders according to the invention a cement-based dry mortar mixture can be formulated which shows a significantly increased tensile adhesion strength after freeze-thaw storage, even when an amount of as low as 2 wt. % of powder is added. This is even more surprising since the amount of hydrophobic monomer used in Ref. Powder P-6 is about comparable to the amount of Biomonomer B-1 used in Powder P-1.

1. Process to prepare a polymer by an aqueous emulsion or suspension polymerisation process wherein a monomer mixture is polymerised in the presence of a free radical initiator and a stabiliser, wherein the monomer mixture comprises:
(i) 0.5-80 wt. % of biomonomers containing an ester of a polyol and at least one fatty acid, the polyol having 2 to 10 hydroxy groups, and at least one vinyl group;
(ii) 20-99.5 wt. % of vinyl monomers chosen from the group of vinyl esters, (meth)acrylic esters, vinyl aromatic compounds, vinyl halides, and olefins; and
(iii) 0 to 20 wt % of vinyl monomers that are different from monomers (ii) and contain at least one functional group chosen from the group of alkoxysilane, glycidyl, epoxy, epihalohydrin, nitrile, carboxyl, amine, ammonium, amide, imide, N-methylol, isocyanate, hydroxyl, thiol, keto, carbonyl, acid anhydride, aceto acetonate, sulfonic acid groups, and salts thereof,
and wherein the stabiliser comprises:
(a) 50 to 100 wt. % of a protective colloid; and
(b) 0 to 50 wt. % of an emulsifier.

2. The process according to claim 1 wherein the vinyl group is incorporated into biomonomer (i) by reacting at least one molecule that introduces the vinyl group with the ester of the polyol and the least one fatty acid.

3. The process according to claim 1 wherein the vinyl group of biomonomer (i) is part of a styrenyl, acrylate, methacrylate and/or vinyl ether group.

4. The process according to claim 1 wherein the polyol is selected from the group of glycol, glycerol, hydroxypropanol, pentaerythritol, 1,1,1-trimethylol propane, 1,1,1-trimethylol ethane, 1,2,3-trimethylol propane, di-trimethylol propane, di-pentaerythritol, ethylene glycol, propylene glycol, neopentyl glycol, 2-butyl-2-ethyl-1,3-propane diol, 1,6-hexane diol, cyclohexane dimethanol.

5. The process according to claim 1 wherein the fatty acid is selected from the group of oleic acid, linoleic acid, a-linoleic acid, [gamma]-linoleic acid, myristoleic acid, arachidonic acid, sapienic acid, erucic acid, palmitoleic acid, gadoleic acid, cetoleic acid, undecylenic acid, punicic acid, or a fatty acid derived from rapeseed oil, castor oil, safflower oil, linseed oil, soybean oil, sesame oil, poppyseed oil, perilla oil, hempseed oil, grapeseed oil, sunflower oil, maize oil, tall oil, whale oil, hevea oil, tung oil, walnut oil, peanut oil, canola oil, cottonseed oil, sugarcane fatty acid.

6. The process according to claim 1 wherein 30 to 100% of the hydroxyl groups of the polyol are reacted with a fatty acid.

7. The process according to claim 2 wherein the ester of the polyol and the at least one fatty acid first reacts with at least one bridging molecule and subsequently a reaction is performed with a molecule that introduces the vinyl group by reaction with the at least one bridging molecule.

8. The process according to claim 2 wherein the molecule that introduces the vinyl group is selected from the group of vinyl-functional compounds that have a functional group capable of reacting with the polyol, the at least one fatty acid chain of the fatty acid ester group or with the bridging molecule.

9. The process according to claim 1 wherein vinyl monomer (ii) comprises 0.1 wt. % to 80 wt. %, based on the total amount of vinyl monomer (ii), of one or more hydrophobic monomers, wherein the hydrophobic monomer is a vinyl ester, (meth)acrylate or (meth)acrylamide having a C-8-C30 alkyl or alkenyl group.

10. The process according to claim 1 wherein in a subsequent step the emulsion is dried to give a powder, a redispersible polymer powder or granulate.

11. An emulsion obtainable from the process according to claim 1.

12. A redispersible polymer powder obtainable from the process of claim 10.

13. A building material composition comprising the emulsion of claim 11 and at least one mineral binder or filler material.

14. A building material composition containing the redispersible polymer powder of claim 12 and at least one mineral binder or filler material.

15. A building material composition of claim 14 that is in the form of a dry uncured mortar.

16. A process to hydrophobise a cured building material composition by adding the emulsion of claim 11 to the uncured building material composition.

17. A process to improve the freeze-thaw stability of a cured building material composition by adding the emulsion of claim 11 to the uncured building material composition.

18. A process to hydrophobise a cured building material composition by adding the redispersible polymer powder of claim 12 to the uncured building material composition.

19. A process to improve the freeze-thaw stability of a cured building material composition by adding the redispersible polymer powder of claim 12 to the uncured building material composition.
